(19) United States
(12) Patent Application Publication
(10) Pub. No.: US 2013/0185891 A1
(43) Pub. Date: Jul. 25, 2013

(54) Disposition Introduced in Windshield Wiper Blade and the Respective Assembly System

(71) Applicant: Marc Nacamuli, Guarulhos (BR)

(72) Inventor: Marc Nacamuli, Guarulhos (BR)

(73) Assignee: ELETROMECANICA DYNA S/A, Guarulhos (BR)

(21) Appl. No.: 13/353,423

(22) Filed: Jan. 19, 2012

(51) Int. Cl. B60S 1/38; B23P 11/00

(52) U.S. Cl. 15/250.201; 29/428; 15/250.48

(57) ABSTRACT

A disposition introduced in windshield wiper blade of automotive vehicles, both on the front and rear, includes a curved shape and a single piece body, which serves to sustain the profile of a vertebra and a blade, allowing the accommodation of the blade with uniform boundary and without deformations. Also disclosed are additional embodiments.

### FIELD OF THE INVENTION

The field refers to a disposition introduced in windshield wiper blade of automotive vehicles, allowing for the accommodation of the blade with uniform boundary and without deformations.

### BACKGROUND OF THE INVENTION

It is known in the art that there are several constructive dispositions introduced in windshield wiper blades.

One of the key features for inspection of the blades refers to the curvature of the blade in contact with the windshield, as well as its accommodation during the movement.

Several dispositions have been developed to adapt the rubber blade to curvature of the windshield. Typically the body of the blade, which holds the rubber blade is composed of at least two distinct components, connected together by various means, resulting in sets having an excessive number of parts and locking means between them. In addition, various metal components are employed. Moreover, the control of the curvature necessary for the blade for high performance becomes very difficult to achieve on the blades that use several components bound together, which harms the uniform distribution of the rubber blade load on the windshield.

In order to solve the drawbacks of the current technology, the applicant has developed a blade body of straw, claimed in the Brazilian request MU8402004-0, where the body of the blade was made in one piece, by the process of co-extrusion of two different shaped material, resulting in a single body with a curved shape throughout its length, allowing for a more uniform load distribution and optimized by the wiper arm.

German patent publication DE10036115 discloses a blade for windshield wiper which has an elongated support rail of resilient material which together with the head part of an adjacent wiper blade fits into a shaped strip that opens on the side of the wiper flap. The shaped strip, the support rail and head part are fitted together by a support block. To be fixed to the shaped strip and the support rail in a predetermined position in relation to one another, there is a locking element, such as a recess, for engagement with a projection formed on the support block.

However, there remains a need for improved windshield wiper blades.

### SUMMARY OF THE INVENTION

In one example, a disposition introduced in a windshield wiper blade and respective assembly system, includes a blade body, being formed in a single piece. The profile of the body includes a top support having flexible material, and a bottom support having rigid material; wherein the union of both the top and bottom supports provide support for other components of said system, said system comprising a vertebra having a vertebra central cutout portions and a blade; the bottom support being a single piece, from one end to another end of the blade. The top support incorporates internal projections and the top support is substantially parallel and symmetrically opposed to the bottom support.

The bottom support includes an assembly channel where the assembly channel passes longitudinally throughout the length of the blade body.

The top support includes internal projections incorporated in its walls and the top support is substantially parallel and symmetrically opposed to the bottom support.

The blade is inserted into an interior formed by the assembly channel. The blade has a top portion having longitudinal grooves conforming with the internal projections of said top support.

The blade body includes a central cutout portion having a substantially rectangular profile for accommodating a central support portion of a wiper and having tip portions. The central support is bipartite and having symmetrically in each part recesses on a top central support portion, and protuberances, and the ends of the blade body are provided with blade body longitudinal cut portions in the top support, and the longitudinal cut portions are positioned on the tip portions.

The tip portions includes a through hole and the tip portions having tip projections being formed in teeth, and the ends of the blade body includes a rectangular cut at the end of the top support.

In another example, a disposition is provided with a blade body endowed with the reduced section with better functional performance, composed of a single piece, by the process of co-extrusion of two different shaped material, resulting into a single body, with a rectilinear shape, acquiring a curved shape in its entirety with the inclusion of a metallic vertebra inside, provided with three different types of cuts, and two cuts on the ends of the body to accommodate the tips and a cut in the central region, to accommodate the central support.

### BRIEF DESCRIPTION OF THE DRAWINGS

Further features and advantages of the invention will become apparent when the following detailed description is read in view of the drawing figures, in which:

FIG. 1 is a side view of the body of the blade.

FIG. 2 is a front view of the blade body, equipped with a symmetric deflector in its upper portion;

FIG. 3 is a side view of another constructive variant of the body of the blade, equipped with an asymmetrical deflector in its upper portion;

FIG. 4 is a front view of another constructive variant of the body of the blade, with an asymmetrical deflector;

FIG. 5 is a perspective view in partial detail of the vertebra being inserted into one of the tips, in a first step of assembly;

FIG. 6 is a perspective view in partial detail of the vertebra already inserted into one of the tips, in a first step of assembly;

FIG. 7 is a perspective view of the second step of assembly, where the vertebra is inserted inside the body of the blade;

FIG. 8 is a perspective view illustrating the assembly of the central support in a third step of assembly;

FIG. 9 is a perspective view of the enlarged detail of the assembly of the central support in a third step of assembly;

FIG. 10 is a perspective view and an enlarged detail of the insertion of the blade under the body of the blade, in a fourth step of assembly;

FIG. 11 is a perspective view of the body of the blade with one of the tips, central support and a blade mounted;

FIG. 12 is a perspective view illustrating the fitting of the last tip, which is the last step of assembly, showing the side, details of the tip individually;

FIG. 13 is a perspective view of the set formed by the central support, body of the blade, vertebra, tips and rubber blade, being assembled.

FIG. 14 is a perspective view of the enlarged detail of the means of fitting the central support in the vertebra and the body of the blade, fitted with a symmetric deflector in its upper portion;

FIG. 15 is a perspective of the central support, showing the bi-partite body being assembled.

FIG. 16 is a perspective of the central support, showing the details of the dispositions thereof;

FIG. 17 is a cutaway view of the assembled set of the blade with the symmetrical deflector, showing a reduction of the profile in the “x” area;

FIG. 18 is a schematic view of the performance of the aerodynamic flow of air over the blade assembly, fitted with a symmetrical deflector, in high-speed;

FIG. 19 is a perspective view in partial detail of the vertebra being inserted into one of the tips of an exemplary embodiment of the invention as described in the Specific Examples section of the specification for example, in the first step of assembly;

FIG. 20 is a perspective view in partial detail of the metallic vertebra already inserted into one of the tips of an exemplary embodiment, in a first step of assembly;

FIG. 21 is a perspective view of the second step of assembly of an exemplary embodiment, where the vertebra is inserted into the support of the blade body;

FIG. 22 is a perspective view illustrating the assembly of the central support in asymmetrical deflector cutout of an exemplary embodiment showing a third step of the assembly;

FIG. 23 is a perspective view of the enlarged detail of the central support fitting on a third step of assembly;

FIG. 24 is a perspective view and an enlarged detail of the insertion of the blade under the body of the blade, in a fourth step of assembly;

FIG. 25 is a perspective view of the body of the blade with one of the tips, the central support and the blade mounted on the channel of the blade;

FIG. 26 is a perspective view illustrating the fitting of the last tip, in the final step of assembly;

FIG. 27 is a perspective view of the assembly of the support center with the asymmetrical deflector, blade body, vertebra, tips and blade, all assembled, forming an exemplary embodiment of the disposition as described in the Specific Examples section, for example;

FIG. 27A is a cutaway view of the assembled blade set with the asymmetrical deflector, showing evidencing a profile reduction in the “x” area;

FIG. 27B is a schematic view of the performance of the aerodynamic flow of air over the blade set, fitted with an asymmetrical deflector, at high speed;

FIG. 28 is a perspective view in partial detail of a vertebra being inserted into one of the tips, in a first step of assembly, showing an exemplary embodiment of the disposition without the deflector as described in the Specific Examples section of the specification, for example;

FIG. 29 is a perspective view in partial detail of the vertebra already inserted into one of the tips, in the first step of assembly, showing an exemplary embodiment of the disposition without the deflector;

FIG. 30 is a perspective view of the second step of assembly, where the vertebra is inserted inside the body of the blade with the tip, showing an exemplary embodiment of the disposition without the deflector;

FIG. 31 is a perspective view illustrating the assembly of the central support of the vertebra, in a third step of the assembly, showing an exemplary embodiment of the disposition without the deflector;

FIG. 32 is a perspective view of the enlarged detail of the assembly of the central support in a third step of assembly, showing an exemplary embodiment of the disposition without the deflector;

FIG. 33 is a perspective view and an enlarged detail of the insertion of the rubber blade under the body of the blade, and the fourth step of the assembly, showing an exemplary embodiment of the disposition without the deflector;

FIG. 34 is a perspective view of the blade body, center support and rubber blade assembled, showing an exemplary embodiment of the disposition without the deflector;

FIG. 35 is a perspective view illustrating the fitting of the last tip, in the last step of assembly, showing on the side, details of the tip individually;

FIG. 36 is a perspective view of the set formed by the central support, body of the blade, vertebra, tips and blade, all assembled, showing an anotherembodiment of the disposition without the deflector;

FIG. 37 is a schematic view in perspective of the known blade assembly of the current art.

### DETAILED DESCRIPTION OF THE INVENTION

The examples and drawings provided in the detailed description are merely examples, which should not be used to limit the scope of the claims in any claim construction or interpretation.

The term “substantially” as used in the specification takes into account minor experimental deviations as understood by a person of ordinary skill. For example, this term can be used with respect to an angular measurement or particular shape, for example. For example, a substantially rectangular can mean an overall rectangular shape, with minor variations that deviate from a rectangular shape.

In the known art, FIG. 37 shows a known blade body of the current art, in which the blade receives two distinct bodies on its assembly, one body to the right and another to the left, mounted on the metallic vertebra, and being displaced to the center of it, until the center support is found. In this constructive arrangement, misalignment may occur between the right and left bodies, resulting in an inefficiency of the rubber blade inserted below them.

To solve the drawbacks of the current art, an exemplary constructive disposition, includes a blade body endowed with the reduced section with better functional performance, and is composed of a single piece, with a rectilinear shape, and said blade body acquires a curved shape in its entirety by including a vertebra inside, the vertebra provided with three different types of cuts, two cuts on the ends of the body to accommodate the tips and a cut in the central region, to accommodate the central support In one example, a process of co-extrusion of two differently shaped materials is used to form a single piece body. Other processes known to persons of ordinary skill may also be used.

First Embodiment of a Disposition Introduced in a Windshield Wiper Blade of Respective Assembly System

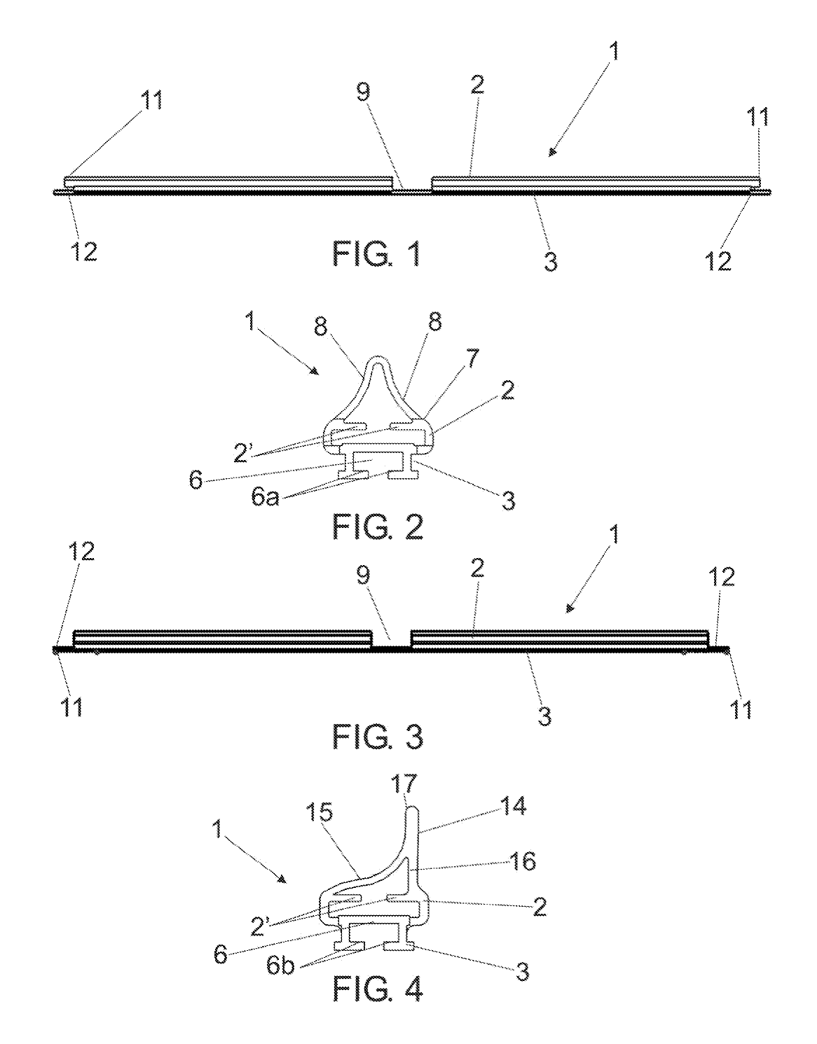

FIG. 1 is a side view of the body of the blade, with an asymmetrical deflector on the upper part, one object, among many, of the present invention.

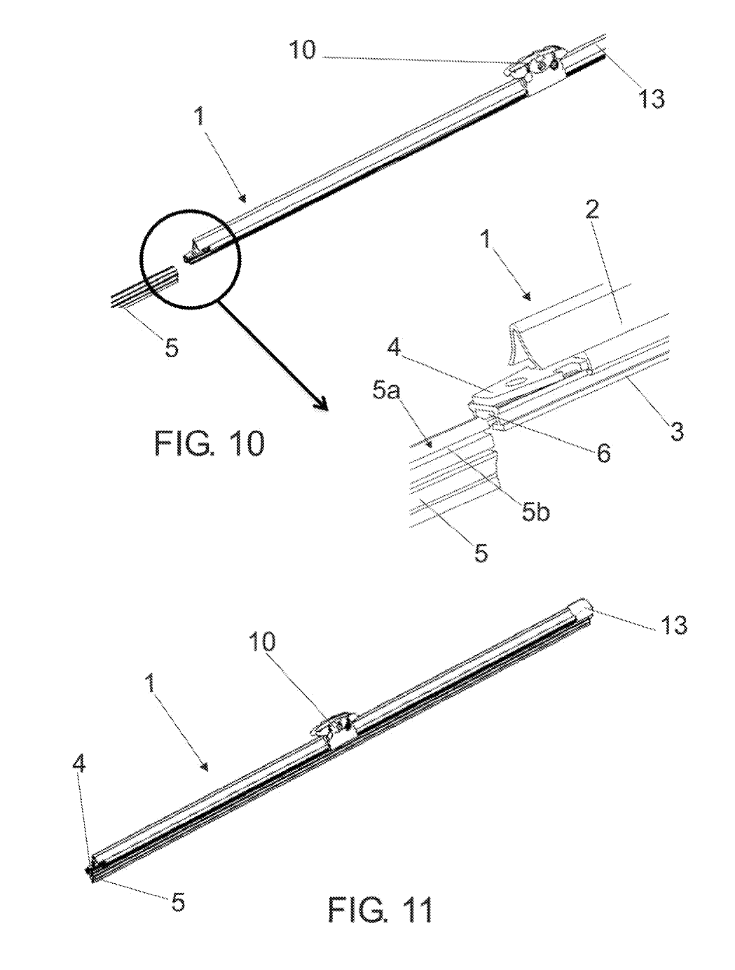

In one example of the claimed invention, a blade body 1 is formed, in a single piece, by the process of co-extrusion of two different shaped materials. The profile of the blade body 1 comprises a top support 2, made of flexible material, and a bottom support 3, consisting of rigid material. Such materials known to a person of ordinary skill may be used for making the top and bottom supports. The union of the two top 2 and bottom 3 supports ensures that the single piece forms the support for the other components of the blade system, including the vertebra 4 and blade 5, shown in FIGS. 6 and 10, for example. In a preferred embodiment, the vertebra is metallic and the blade is rubber. Other materials known to persons of ordinary skill in the art may be used for the composition of the vertebra and blade respectively.

This same junction forms an inner chamber 6 also in profile and preferably rectangular and flat shape, whose function is to secure and maintain the blade 5 in uniform contact with the windshield.

The bottom support 3 is made in a single piece from end to end of the blade. The bottom support 3 has an assembly channel 6, passing longitudinally throughout the length of the blade body 1, preferably of rectangular form, as shown in FIG. 2. On the walls of the top support 2, internal projections 2′ are incorporated and are parallel to the bottom support 3 and symmetrically opposed to each other, forming an inner chamber profile. Internal projections 2′ are also preferably rectangular shape and flat, and functions to keep the vertebrae 4 pressing the blade 5 as well as to be in uniform contact with the windshield.

As shown in FIG. 10, the blade 5 is inserted in the interior formed by the channel 6 and the top 5a part is molded with longitudinal grooves 5b to conform with internal projections 6a (FIG. 2) of the channel 6.

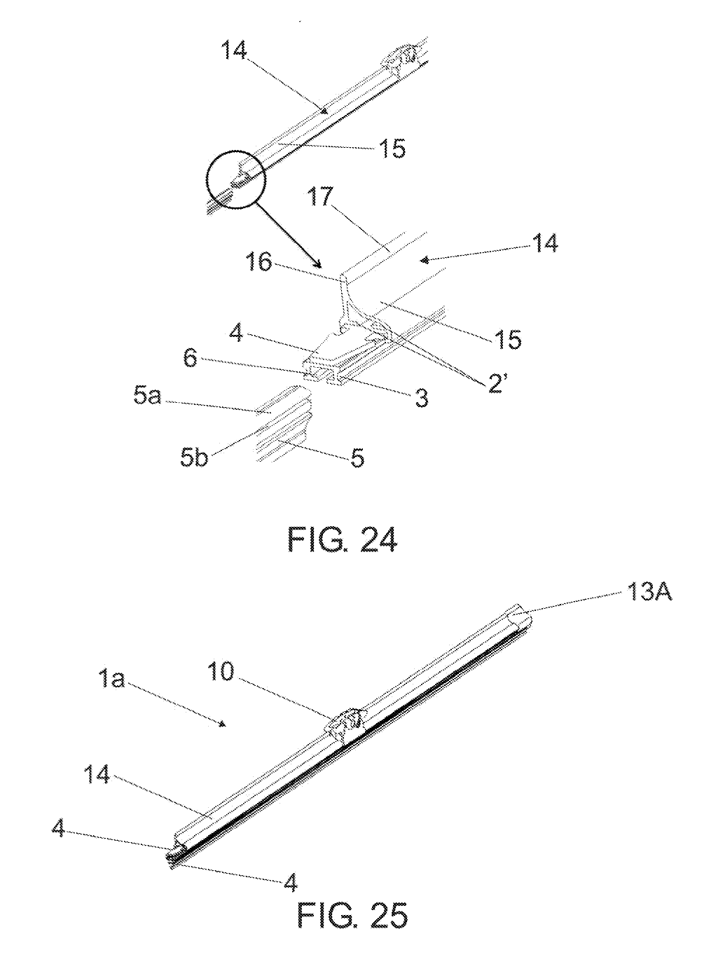

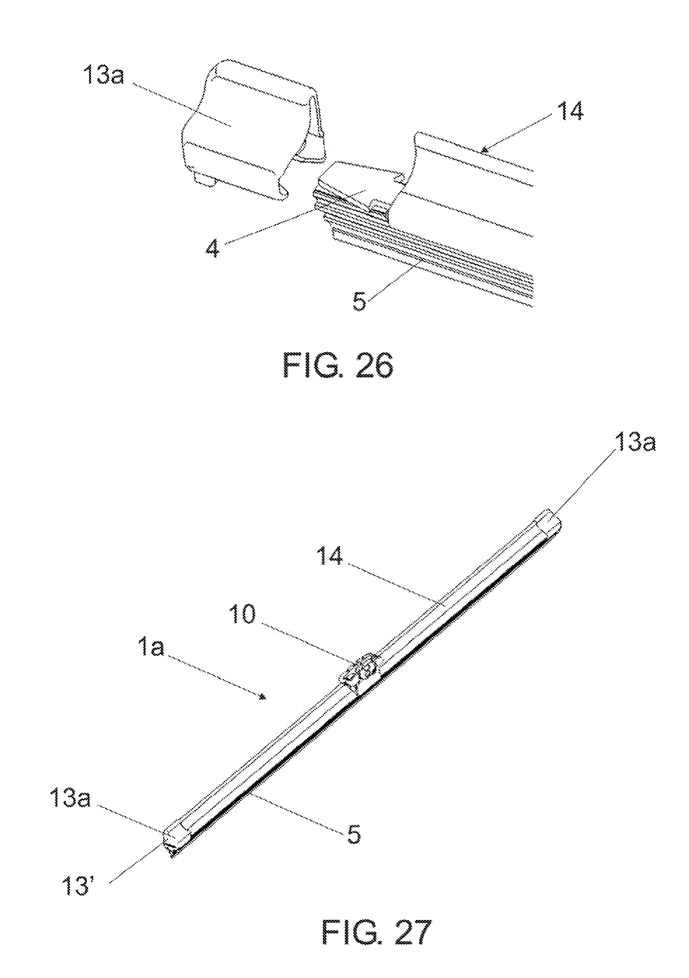

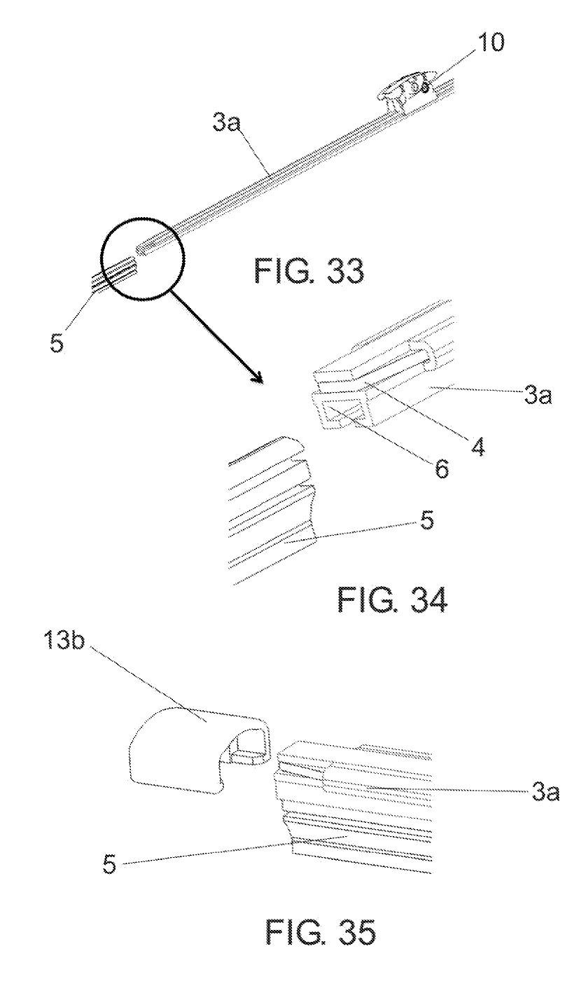

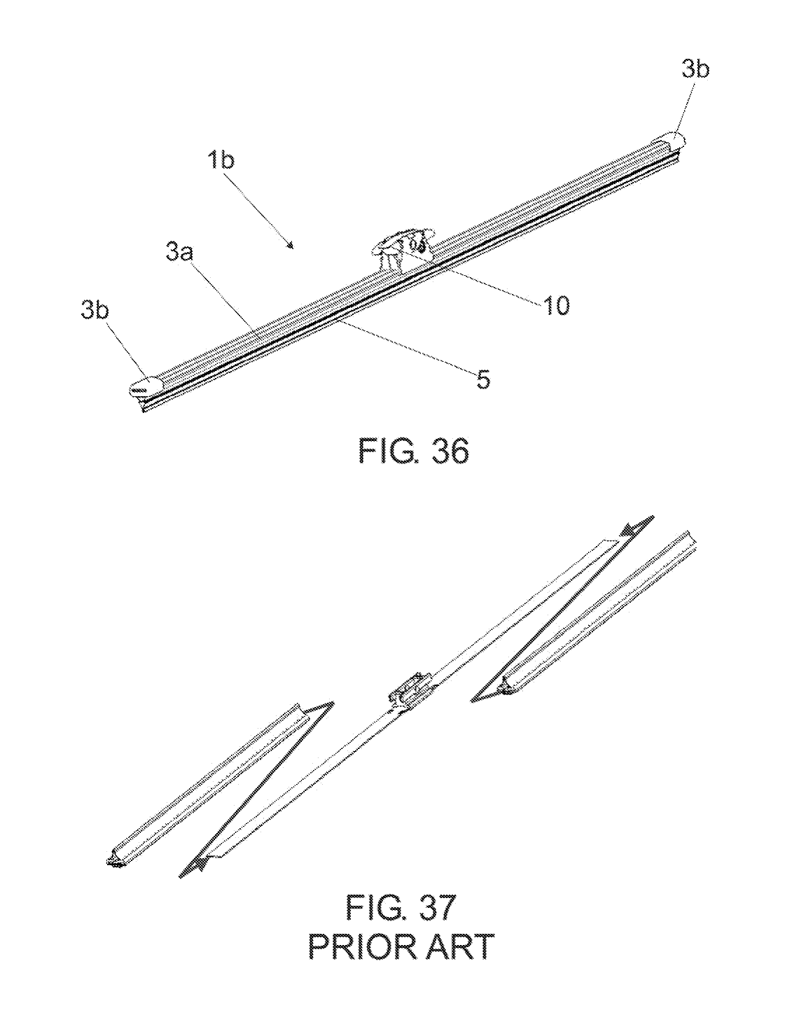

In addition to the preferred embodiment, two constructive variations of the blade body 1, whose assembly of its components will be detailed based on FIGS. 1 to 13 and 19 to 36.

FIGS. 1 and 2 show a first embodiment for the profile of the blade body 1, where the top support 2 of the blade body 1 has in its upper portion a symmetrical deflector 7, being formed by symmetric concave blades 8.

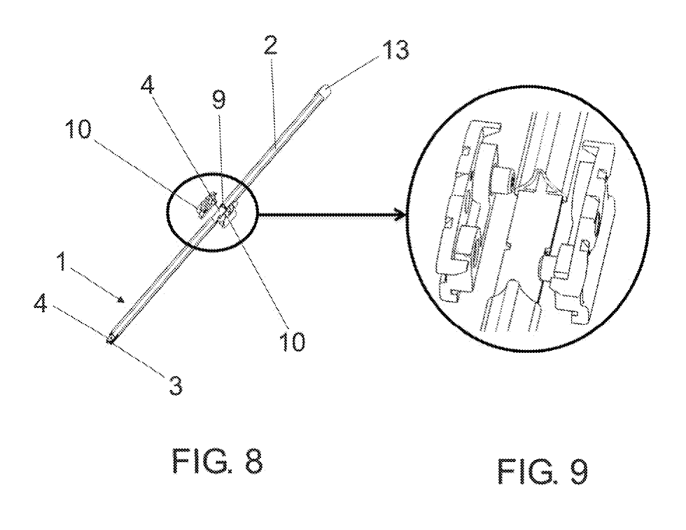

As shown in FIGS. 3 and 8, for example, the blade body 1 has on the top support 2 a central cutout 9, which forms a semi divisional and median interval from the upper part 2 to accommodate the central support 10 of the wiper.

As shown in FIGS. 1, 2, and 7, for example, the ends 11 of the body 1 are provided with longitudinal cuts 12 in the top support 2, on which are positioned the tips 13 of the blade.

### Exemplary First Step of Assembly of the Disposition

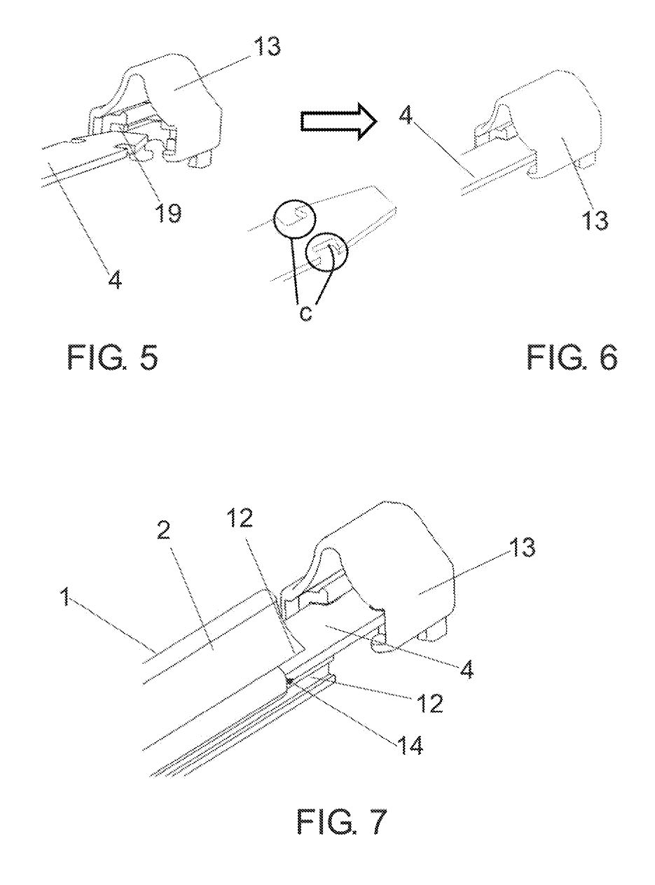

FIG. 5 is a perspective view in partial detail of the vertebra 4 being inserted into one of the tips 13 of the blade in a first step of assembly of the disposition.

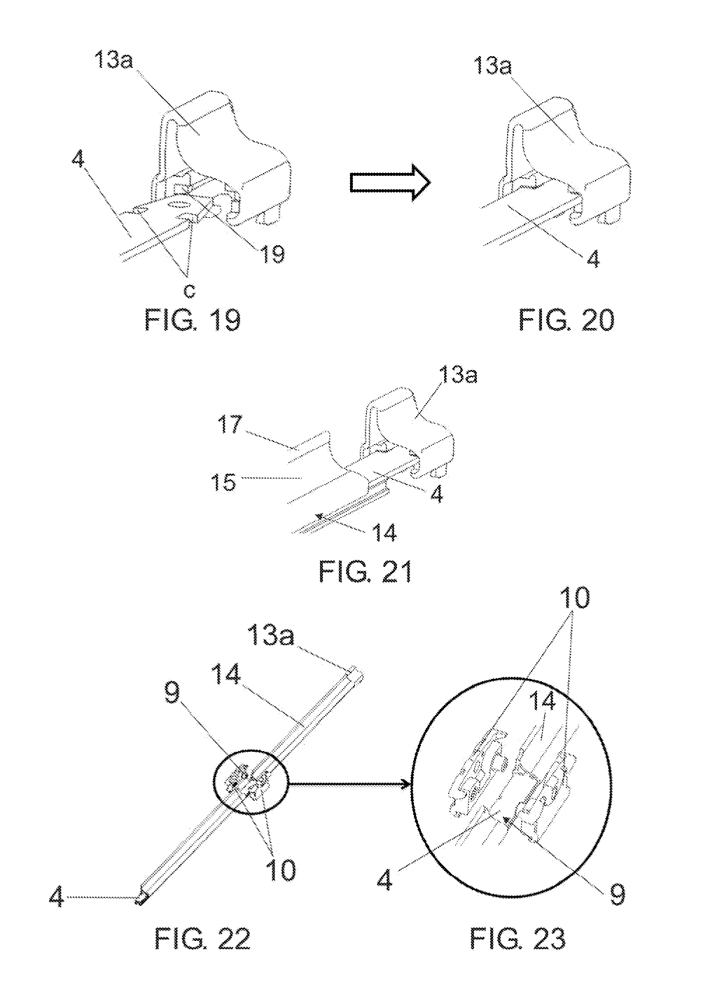

In one example, the blade is made from the assembly of components in the following sequence: first, according to FIGS. 5 and 6, FIGS. 19 and 20, FIGS. 28 and 29, in the first step of assembling, one of the tips 13, i.e., 13a and 13b (FIGS. 19, 20, 28, 29) is seated and accommodates a vertebra end 4, receiving the vertebra in a rectangular chamber 19 and the mentioned vertebra 4 may be used in a symmetrical or an asymmetrical version.

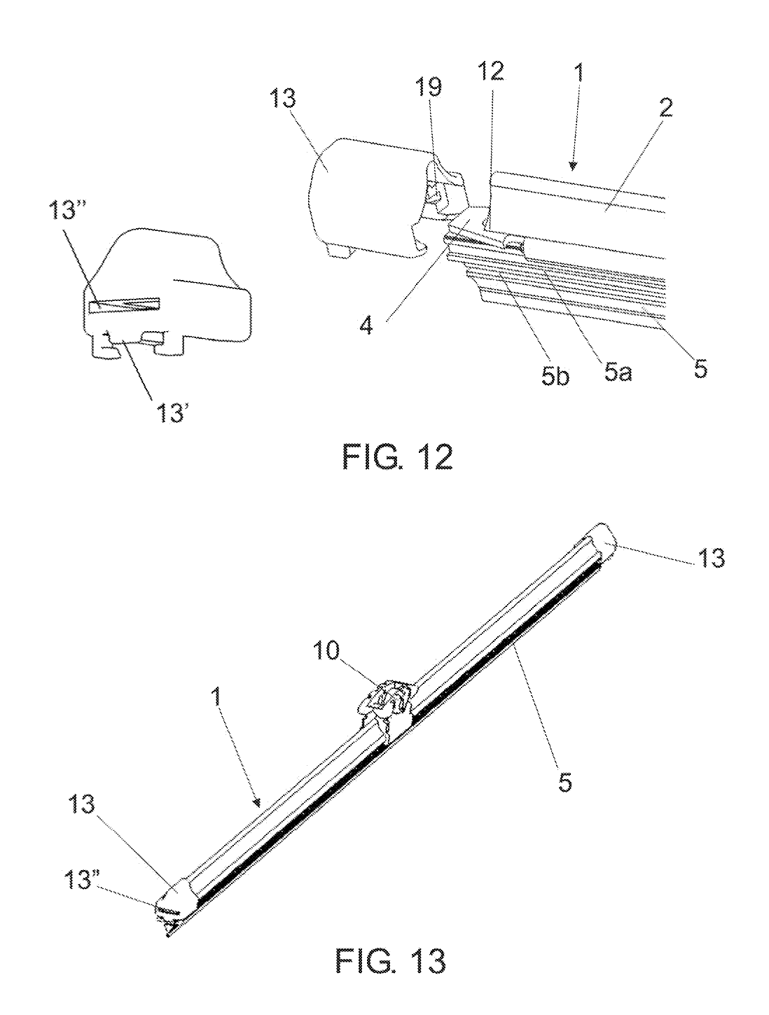

As shown in FIGS. 7 to 13; 19 to 21; and 28 to 35, the tips 13, 13a and 13b in addition to providing finishing in a manner consistent with the deflector 7, are endowed with a pass-though rectangular shaped hole 13″ (shown in FIGS. 12, 13, for example) that does not allow the vertebra 4 to damage the end of the tip, in case of collision between the tip and the vertebra. Each tip 13, 13a, 13b also includes projections in the shape of teeth 13′, reentrant, which do not allow for the removal of the blade body 1 and the blade 5.

### Exemplary Second Step of Assembly of the Disposition

As shown in FIGS. 7, 21 25, 30, and 36, in the second step of assembly, the blade body 1, 1a, 1b, is placed on the metallic vertebra 4 by the interior of the top support 2 and runs throughout its longitudinal extent, by the end opposite the end where the first tip 13, 13 a, 13b is positioned, until touching the vertebra 4.

### Exemplary Third Step of Assembly of the Disposition

FIGS. 8 and 9, 22 and 23, and 31 and 32 show the third step of the system assembly, in which the central support 10 is attached to the central cutout 9 to substitute for the vertebra 4.

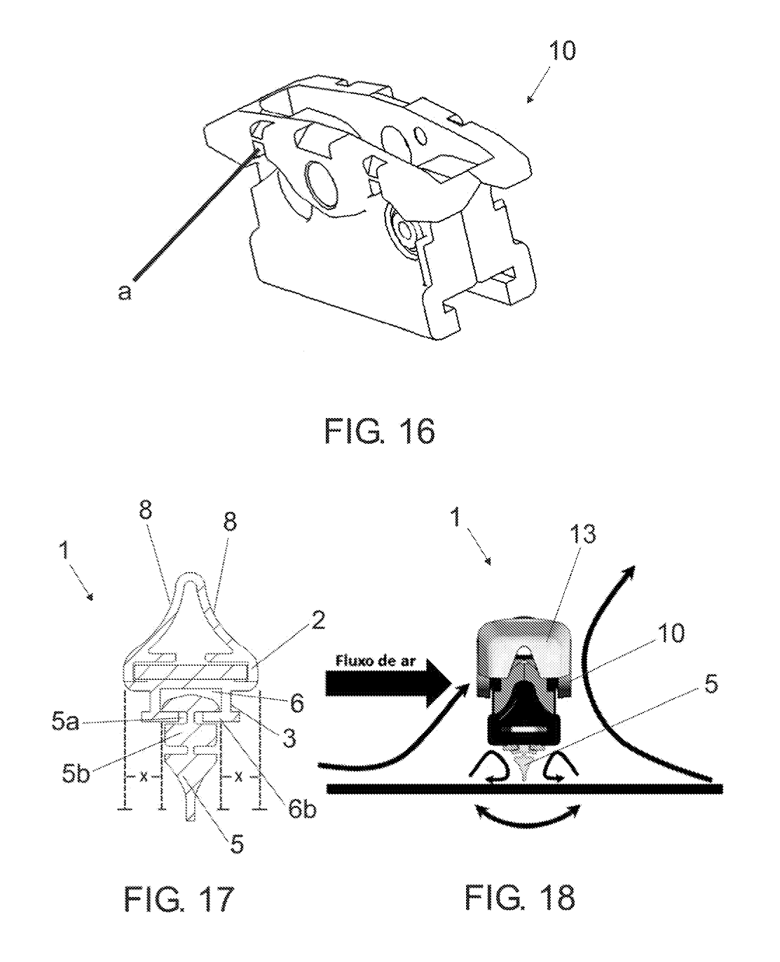

As shown in FIGS. 8 and 9 and 14 to 16, for example, the central support 10 is bipartite and has symmetrically in its parts the recesses (a) on each top part and the trapezoidal bulges (b) that form an internal longitudinal rail to fit into the central cutouts 4′ of the vertebra 4 in the space formed by the central cutout 9 of the top support 2, overlapping with the metallic vertebra 4 previously inserted in the body 1, making the set locked in the longitudinal direction.

### Exemplary Fourth Step of Assembly of the Disposition

FIG. 10 shows the fourth step of the assembly, in which the blade 5 is inserted into the lower channel 6 of the bottom support 3 passing longitudinally through the entire length of the blade body 1. The bottom support 3 in a single piece sustains the entire length of the blade 5, and, also, follows the curvature of the vertebra 4 in any condition, despite the effect of loading on the blade body 1, thereby ensuring its support.

FIG. 11 shows the blade body 1 with one of the tips 13, central support 10 and rubber blade 5 assembled.

### Exemplary Fifth Step of Assembly of the Disposition

FIG. 12 shows the fifth and final step of assembly of the blade body 1. After inserting the blade 5, which runs along the entire length of the body 1, the last tip 13 is inserted at a free end of the vertebra 4 until the last tip settles into the longitudinal cuts 12 of the top support 2, finishing the assembly of the disposition.

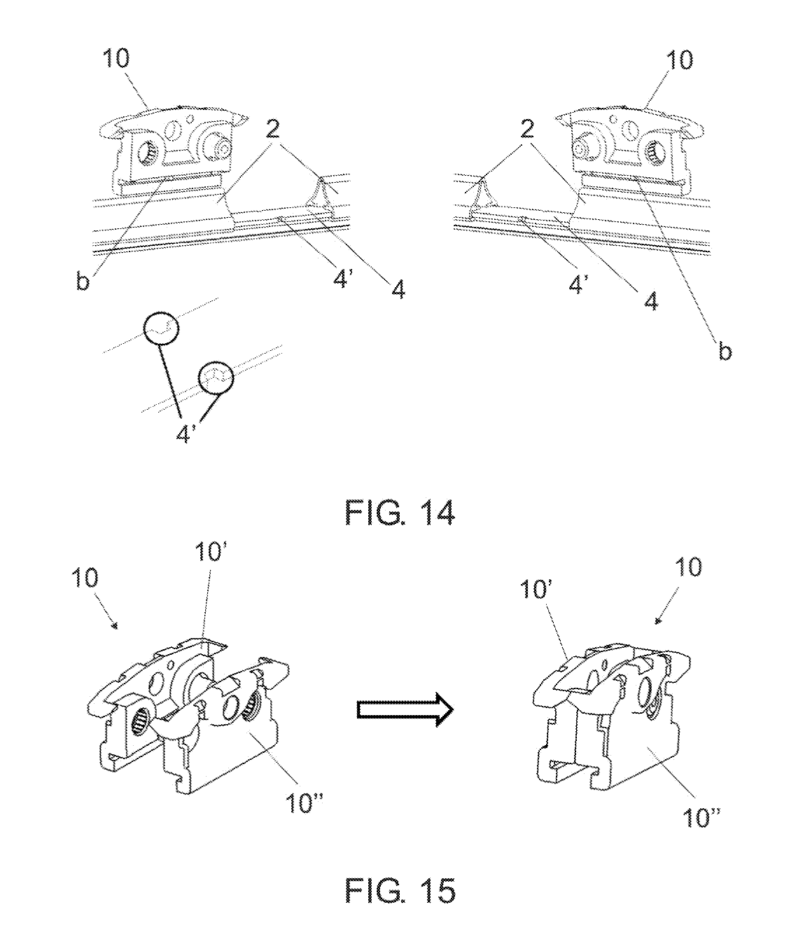

FIG. 14 is a perspective view of the assembly of the disposition formed by the central support 10, the blade body 1, vertebra 4, tips 13 and blade 5, all assembled. The vertebra may be metallic, in one example, and the blade may be rubber, in one example.

Thus, the windshield wiper blade that has a curved shape which has a profile composed of a single co-extruded body, which accommodates the vertebra 4 and guides the blade 5, ensuring total uniformity in its entire length, following in all points with accuracy the curvature established by the vertebra 4.

### Symmetrical vs. Asymmetrical Vertebrae

In the case of symmetrical vertebrae, the initial side of the fitting of the body 1 does not matter, whereas in the case of asymmetric vertebrae, a person of ordinary skill must observe the correct side for starting the assembly, since the cutout 9 in which the central support 10 will be fitted must accompany their center in one example.

### Symmetrical Vertebrae

As shown in FIGS. 17 and 18, the blade body 1 set is assembled, with a symmetric deflector in its upper portion, and a vertebra, showing a reduction of the profile formed in the “x” area, allowing for an embodiment that results in a smaller area of friction with the air flow, and allowing the cleaning quality to be maintained with the vehicle at high speed and avoiding turbulence against the wiper blade, an effect known as “wind lift”, performance that is shown in FIG. 18 depicting a schematic representation of the performance of the aerodynamic flow of air over a blade assembly 1, which is fitted with a symmetrical deflector, at high speed.

### Asymmetrical Vertebrae

Alternatively, as shown in FIG. 4, the top support 2 of the blade body 1 of asymmetrical profile also has two assembly channels, passing longitudinally throughout the length of the blade body 1, preferably of rectangular format, within which is inserted the vertebra 4. Vertebra 4 functions to secure and maintain the blade 5 in uniform contact with the windshield.

Second Embodiment of a Disposition Introduced in a Windshield Wiper Blade of Respective Assembly System

A second constructive alternative for the profile of the blade body 1 is shown in FIG. 4, where the top support 2 of the blade body 1 has in its upper portion an asymmetrical deflector 14, formed by a concave curve blade 15 and a vertical wall 16, joined by an upper apex 17 being substantially lengthened. This constructive alternative of the asymmetrical deflector 14 also incorporates internal projections 2′ and being parallel to the bottom support 3 and symmetrically opposed to each other.

As can be seen in FIGS. 19 to 21, in a second embodiment of the invention, the vertebra 4 is inserted into one of the tips 13a in the first step of assembly, and the remaining steps of the assembly system also proceeded according to the first preferred variation described previously.

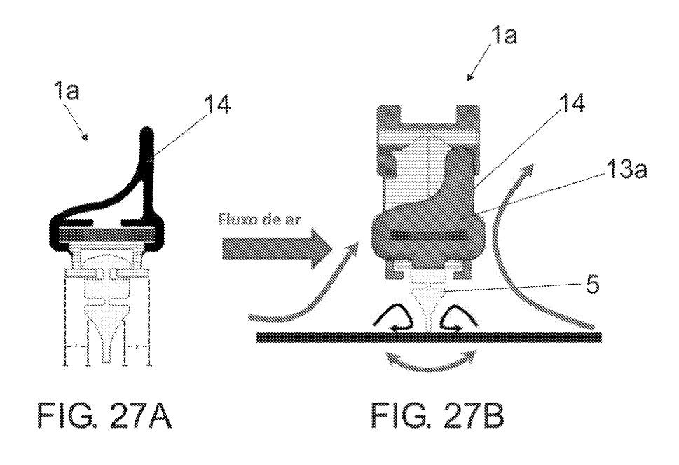

As shown in FIGS. 27A and 27B, the blade body 1 set is assembled with the asymmetrical deflector 14 in its upper portion to the metallic vertebra, showing a reduction of the profile formed in the “x” area, resulting in an embodiment that results in a smaller area of friction with the air flow, allowing the cleaning quality to be maintained with the vehicle at high speed and avoiding turbulence against the wiper blade, an effect known as “wind lift.” Such performance can be shown in FIGS. 27A and 27B where the schematic representation of the performance of the aerodynamic flow of air over a blade assembly, fitted with a symmetrical deflector, at high speed, is shown.

Third Embodiment of a Disposition Introduced in a Windshield Wiper Blade of Respective Assembly System

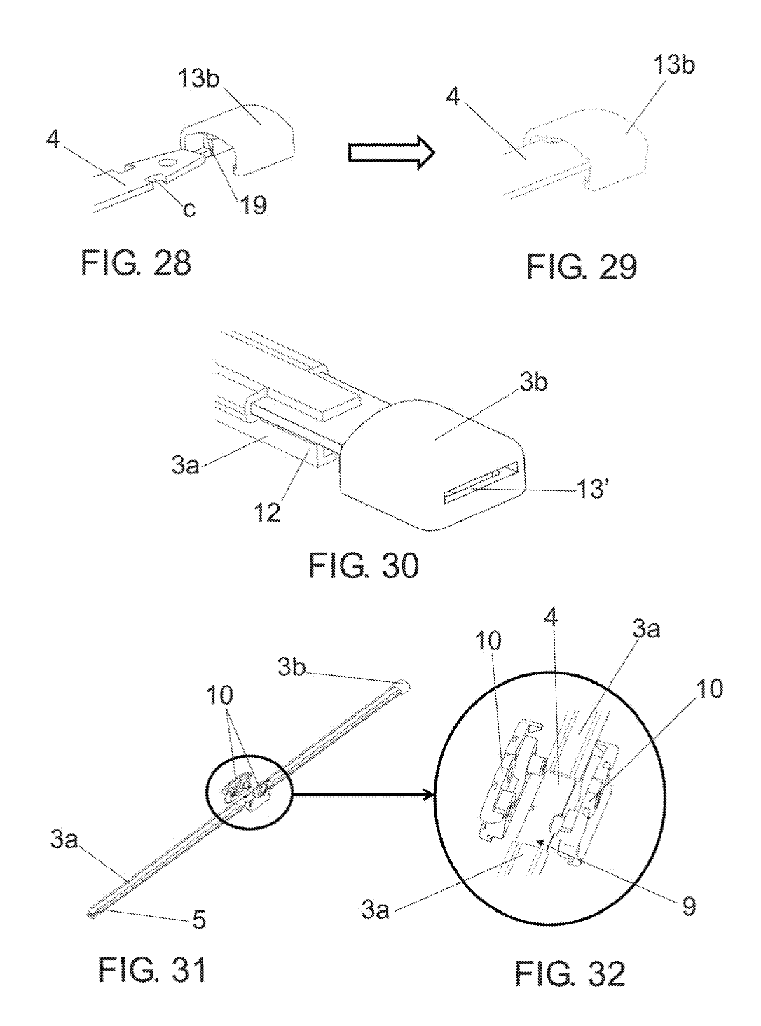

FIGS. 28 to 36 show a third more streamlined constructive alternative for the body profile of the blade 1, where the top support 2 of the blade body 1 does not have a deflector, further decreasing the area of friction with the airflow. In this example, the assembly system is performed as follows: the metallic vertebra 4 is inserted into one of the tips 13b in the first step of assembly, and the remaining steps of the assembly proceed exactly according to the first preferred variation described above.

### Specific Examples

The following paragraphs describe specific examples of embodiments that are covered by the scope of the claims.

In a first embodiment, a disposition comprises a blade body 1 formed, in a single piece, by the process of co-extrusion of two different shaped materials; the profile of said blade body 1 is comprised of a top support 2, made of flexible material, and a bottom support 3, consisting of a rigid material. The union of both the top 2 and bottom 3 supports, provides support for other components in the blade system, including the metallic vertebra 4 equipped with central cutouts 4′; and the rubber blade 5.

The bottom support 3 is composed in a single piece, from one end to another of the blade; in the top support 2 are incorporated the internal projections 2′ and parallel to the bottom support 3 and symmetrically opposed to each other, the said bottom support 3 has an assembly channel 6 of profile and format preferably rectangular and flat, passing longitudinally throughout the length of the blade body 1, preferably of rectangular shape, in the walls of the top support 2 are incorporated into the internal projections 2′ and parallel to the bottom support 3 and symmetrically opposed to each other, in the interior formed by the channel 6 is inserted into the rubber blade 5, whose top 5a is molded with longitudinal grooves 5b in configuration according to the internal projections 6a of the channel 6. The top support 2 of the blade 1 has in its upper portion a symmetrical deflector 7, formed by concave blades 8 and; the blade body 1 has in the top support 2 a central cutout 9, of rectangular profile, which accommodates the central support 10 of the wiper, which is bipartite and has symmetrically in its parts the recesses (a) on each top and the trapezoidal protuberances (b).

The ends 11 of the body 1 are provided with longitudinal cuts 12 in the top support 2, which are positioned on the tips 13 of the blade, which have a through hole in rectangular format 13″ and projections in the form of teeth 13′, reentrant; the ends 11 of the body 1 have a rectangular cut at the end of the top support 2.

The exemplary process of making a disposition may occur in the following way. In one exemplary process, the disposition is characterized by, in the first step that one of the tips 13 is fit and housing the end of the metallic vertebra 4, receiving it in a rectangular chamber 19, and the mentioned vertebra 4 may be symmetric or asymmetric. The blade body 1 is placed on the metallic vertebra 4 inside the top support 2 and runs along its longitudinal extension, on the end opposite to the end where the first tip 13 is positioned, until touching it. In the second step, the bottom support 3; 3a and 3b of blade body 1, 1a, 1b of the assembly system is fit into the metallic vertebra 4 through its interior and runs along its longitudinal extension, on the end opposite to the end where the first tip 13; 13 a; 13b is positioned, until touching it. In the third step, the central support 10 fits into the central cutout 9 of the central cutouts 4′, overlapping with the metallic vertebra 4 already inserted in the body. In the fourth step of assembly, the blade 5 is inserted into the lower channel 6 of the bottom support 3 passing longitudinally throughout the length of the blade body 1. In the fifth and final step of assembly of the blade body 1, the last tip 13 is inserted into the free end 11 of the vertebra 4, until settling in longitudinal cuts 12 of the top support 2, finishing the set assembly, forming the “x” area.

In a second embodiment further limiting the foregoing dispositions previously described in the previous paragraphs, the disposition includes in the profile of the blade body 1 that the top support 2 of the blade body 1 has in its upper portion an asymmetrical deflector 14, being formed by a concave curve blade 15 and a vertical wall 16 joined by an substantially elongated upper vertex 17. The deflector 14 also has two assembly channels, passing longitudinally throughout the length of the blade body 1, of substantially rectangular shape, within which the metallic vertebrae 4 are introduced, also in preferably rectangular and flat profile and shape; and the mentioned asymmetrical deflector 14 also incorporates internal projections 2′ and parallel to the bottom support 3 and symmetrically opposed to each other.

In a third embodiment further limiting the foregoing first embodiment and the exemplary process, the disposition, includes in the profile of the blade body 1, that the top support 2 of the blade body 1 does not have a deflector, and the metallic vertebra 4 is inserted into one of the tips 13b in the first step of assembly, and the remaining stages of the assembly system also proceeds according to the preferred variation described in the foregoing exemplary process.

### Advantages of the Disposition

The claimed invention also offers variations as to the various types of applications offered on the market, by simply replacing central supports, couplings or adapters, which makes it a versatile and functional invention.

One advantage among many, in one example, the central region of the single body eliminates the possible misalignment as presented in many prior art structures, and the said single body accommodates the metallic vertebra and rubber blade along the entire length, ensuring aerodynamic effect throughout its profile or its variants, resulting in a conception that results in a smaller area of friction with the air flow, allowing the cleaning quality to be maintained with the vehicle at high speed and avoiding turbulence against the wiper blade, an effect known as “wind lift”.

Moreover, the components of an exemplary disposition presents specific embodiments responsible for providing a perfect fit between the parts, facilitating the assembly of the final product. The central support, a key component of the blade, is developed in bipartite body, which allows various systems of lateral connection (slide lock) and for connecting on the upper face (Top Lock), whether they are pivotable or not.

One advantage of the disposition, among many, is that the central region of the single body eliminates the possible misalignment of the current art, and the single body accommodates the vertebra and blade along the entire length, ensuring aerodynamic effect throughout its profile or its variants, resulting in an embodiment that results in a smaller area of friction with the air flow, allowing the cleaning quality to be maintained with the vehicle at high speed and avoiding turbulence against the wiper blade, an effect known as “wind lift”.

Moreover, the exemplary embodiments provide a perfect fit between the parts, facilitating the assembly of the final product. In one example, the central support, a key component of the blade, is developed in bipartite body, which allows various systems of lateral connection (slide lock) and for connecting on the upper face (top Lock), whether they are pivotable or not.

It is one object, among many, to provide a secure mounting system that overrides the standard means of connection between the components, due to the central support having in its incorporation bulges and recesses of additional security in the assembly.

In function of the new connection systems, this product can be used in the most varied applications disposed in catalogs to the conventional system currently used in large scale and also in windshield wiper blades, both front and rear, in setup

The following is a list of reference numerals and associated parts as used in this specification and drawings:

| Reference Numeral | Part |
|---|---|
| 1 | Blade body |
| 1a | Blade body |
| 1b | Blade body |
| 2 | Top support |
| 2′ | Internal projections |
| 3 | Bottom support |
| 4 | Vertebra |
| 4′ | Cutouts |
| 5 | Blade |
| 5a | Top blade portion |
| 5b | Longitudinal grooves |
| 6 | Channel |
| 6a | Internal projections |
| 7 | Deflector |
| 8 | Blade |
| 9 | Central cutout portion |
| 10 | Central support |
| 11 | Blade ends |
| 12 | Longitudinal cut portions |
| 13 | Tip |
| 13′ | Teeth |
| 13″ | hole |
| 13a | Tip |
| 13b | Tip |
| 14 | Asymmetrical deflector |
| 15 | Concave curve blade |
| 16 | Vertical wall |
| 17 | Upper apex |
| 19 | Chamber |
| (a) | Recess |
| (b) | Protuberance |

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A disposition introduced in a windshield wiper blade and respective assembly system, comprising:
a blade body, being formed in a single piece, the profile of the body comprising a top support having flexible material, and a bottom support having rigid material; wherein the union of both the top and bottom supports provide support for other components of said system, said system comprising a vertebra having a vertebra central cutout portions and a blade;
the bottom support being a single piece, from one end to another end of the blade; the top support incorporating internal projections, the top support being substantially parallel and symmetrically opposed to the bottom support;
the bottom support including an assembly channel, the assembly channel passing longitudinally throughout the length of the blade body;
the top support having the internal projections incorporated in its walls and the top support being substantially parallel and symmetrically opposed to the bottom support;
wherein the blade is inserted into an interior formed by said channel, the blade having a top portion having longitudinal grooves conforming, with the internal projections of said top support; and
the blade body including a central cutout portion having a substantially rectangular profile for accommodating a central support of a wiper and having tip portions; said central support being bipartite and having symmetrically in each part recesses on a top central support portion, and protuberances, and the ends of the blade body being provided with longitudinal cut portions on the top support, the longitudinal cut portions being positioned on the tip portions, the tip portions having a through hole and the tip portions having tip projections being formed in teeth, and the ends of said body having a rectangular cut at the end of the top support.

2. The disposition of claim 1, wherein the top support having in its upper portion a substantially symmetrical deflector, being formed by concave blades.

3. The disposition of claim 1, wherein a top support of the blade body includes an asymmetrical deflector being formed by a concave curve blade and a vertical wall joined by a substantially elongated upper vertex; wherein the asymmetrical deflector includes two assembly channels for passing longitudinally throughout the length of the blade body, said channels being of substantially rectangular shape, within said assembly channels, the vertebra is introduced; and said deflector incorporating internal projections being parallel to the top support and said projections of deflector being symmetrically opposed to each other.

4. The disposition of claim 1, wherein the top support of the blade body is free of a deflector.

5. The disposition of claim 1, wherein the blade body is formed in a single piece, by co-extrusion of two differently shaped materials.

6. The disposition of claim 1, wherein the vertebra is metallic.

7. The disposition of claim 1, wherein the blade is of a rubber material.

8. The disposition of claim 1, wherein the blade body is of rectangular shape.

9. The disposition of claim 1, wherein the thorough hole of the tip portion is rectangular shaped.

10. The disposition of claim 1, wherein the assembly channel has a rectangular and flat profile and shape.

11. A method of assembling a disposition introduced in a windshield wiper blade and respective assembly system, the method comprising the following steps:
a first step of assembly comprising:
providing tip portions:
fitting one of the tip portions and housing the end of a vertebra;
receiving it into a chamber; and
placing a blade body on the vertebra inside a top support and running along its longitudinal extension on an end opposite to the end where the first tip portion of the tip portion is position until touching the first tip portion; and
a second step of assembly comprising:
fitting a bottom support into the vertebra through the interior of the vertebra and running along the longitudinal length of the vertebra, to an end opposite to where the first tip portion is positioned until touching it; and
a third step of assembly comprising:
fitting a central support into a central cutout portion of the top support of a central cutout portion of the vertebra;
a fourth step of assembly comprising:
inserting the blade into an assembly channel of the bottom support, passing the blade longitudinally throughout the length of the blade body; and
a fifth step of assembly comprising:
inserting the last tip portion of the tip portions into a free end of the vertebra, until reaching the longitudinal cut portions of the top support, thereby finishing the assembly process, forming a “x” area.

12. The method of claim 11, wherein the first step of assembly includes providing a symmetrical vertebra.

13. The method of claim 11, wherein the first step of assembly includes providing a asymmetrical vertebra.

14. The method of claim 11, wherein the steps of assembling includes providing a top support of the blade body having an asymmetrical deflector being formed by a concave curve blade and a vertical wall joined by a substantially elongated upper vertex; wherein the asymmetrical deflector includes two assembly channels for passing longitudinally throughout the length of the blade body, said channels being of substantially rectangular shape, within said assembly channels, the vertebra is introduced; and said deflector incorporating internal projections being parallel to the top support and said projections of deflector being symmetrically opposed to each other.

15. The method of claim 11, wherein the first step of assembling includes providing the top support of the blade body being free of a deflector, and the vertebra being inserted into one of the tip portions in the first step.
